(19) United States
(12) Patent Application Publication
(10) Pub. No.: US 2019/0225749 A1
(43) Pub. Date: Jul. 25, 2019

(54) POLYAMIDE RESIN COMPOSITION WITH REDUCED RADIATION NOISE

(71) Applicants: HYUNDAI MOTOR COMPANY, Seoul (KR); KIA MOTORS CORPORATION, Seoul (KR)

(72) Inventors: Hyun-Jun KIM, Suwon-Si (KR); Byung-Hyun LEE, Bucheon-Si (KR)

(21) Appl. No.: 16/209,105

(22) Filed: Dec. 4, 2018

(30) Foreign Application Priority Data
Jan. 25, 2018 (KR) 10-2018-0009054

(51) Int. Cl. C08G 69/26; C08K 7/14; C08K 3/22; C08K 3/30; C08K 5/544

(52) U.S. Cl. CPC C08G 69/26; C08K 7/14; C08K 3/22; C08K 3/30; C08K 5/544; C08K 2201/004; C08K 2003/2241; C08K 2003/2272; C08K 2003/2296; C08K 2003/3036; C08K 2201/003; C08G 2350/00

(57) ABSTRACT

A polyamide resin composition with reduced radiation noise includes 50 to 66 wt % of polyamide 66, 30 to 40 wt % of glass fiber, and 3 to 5 wt % of a vibration-damping inorganic material, based on the entire resin composition. The vibration-damping inorganic material is selected from the group consisting of antimony oxide (Sb₂O₃), barium sulfate (BaSO₄), zinc oxide (ZnO), zinc sulfide (ZnS), titanium dioxide (TiO₂), and iron oxide (Fe₂O₃).

### CROSS-REFERENCE TO RELATED APPLICATIONS

This application claims priority under 35 U.S.C. § 119 to Korean Patent Application No. 10-2018-0009054, filed on Jan. 25, 2018, in the Korean Intellectual Property Office, the disclosure of which is incorporated herein by reference in its entirety.

### TECHNICAL FIELD

The present disclosure relates to a polyamide resin composition with reduced radiation noise, and more particularly, to a polyamide resin composition with reduced radiation noise, which includes polyamide 66, glass fiber, and a vibration-damping inorganic material and suppresses radiation noises generated from vehicle engine parts.

### BACKGROUND

In general, various devices required to run a vehicle, such as an engine required for driving, a transmission device which utilizes power generated from the engine, an intake and exhaust device related to the inflow and discharge of fuel and exhaust gas, and a cooling device which efficiently manages heat generated from the engine, are installed in an engine room of the vehicle.

Among them, the engine plays the most important role to generate a driving force through combustion of an automotive fuel. The engine includes a cylinder block which has a plurality of bores formed therein, a piston which is inserted into each bore of the cylinder block and reciprocates, a cylinder head which is disposed at an upper end portion of the cylinder block and forms a plurality of combustion chambers corresponding to each bore therein, a crankcase which is disposed at a lower portion of the cylinder block and has a crankshaft that is connected to the piston and converts a reciprocal movement of the piston into a rotational movement of the piston, and the like.

Since an up-and-down movement of the piston in the cylinder and a rotational movement of the crankshaft, which are accompanied by strong forces, are generated when the engine is driven, a big vibration is generated in the engine itself. Simultaneously, rotation sound is generated from the surface of a part by the vibration, and the higher the exciting force is, the higher the amplitude of radiation sound is, and as a result, the sound is changed in the form of noise.

In particular, due to the trend in the automotive industry, in which various technologies for increasing the output and the torque while reducing the size of an engine are combined, the vibration of the engine further intensifies, and the amplitude of the noise caused by the vibration is also further increased.

Accordingly, a polymer having a relatively better vibration damping capacity and a higher damping ratio than a metal is being applied to a cylinder head cover, a timing belt/chain cover, and an engine oil pan part, which are cover parts mounted on an automotive engine.

According to the related art, a material usually used in the engine part is glass fiber-reinforced polyamide 66, and the vibration damping capacity level is only at a level of the damping ratio of 3.0 to 3.5%.

Thus, the present disclosure has been made in an effort to suppress the amplitude of vibration generated from the surface of an engine by significantly improving the vibration damping capacity as compared to a level of a damping ratio of 3.0 to 3.5%, which is a damping capacity level of a material according to the related art, and to reduce the amplitude of radiation sound.

### SUMMARY

The present disclosure has been made in an effort to provide a polyamide resin composition with reduced radiation noise, which reduces the amplitude of noise by damping the amplitude of vibration generated from the surface of an engine and suppressing the degree to which the vibration is changed into radiation sound.

According to an exemplary embodiment of the present disclosure, a polyamide resin composition with reduced radiation noise includes: 50 to 66 wt % of polyamide 66, 30 to 40 wt % of glass fiber; and 3 to 5 wt % of a vibration-damping inorganic material, based on the entire resin composition.

0.3 to 1.0 wt % of an amino silane coupling agent may be further included.

The polyamide 66 may have a relative viscosity of 2.7 to 3.5.

The polyamide 66 may have a number average molecular weight of 20,000 to 50,000.

The glass fiber may have a diameter of 8 to 15 μm.

The glass fiber may have a length of 2 to 5 mm.

The vibration-damping inorganic material may be selected from antimony oxide (Sb₂O₃), barium sulfate (BaSO₄), zinc oxide (ZnO), zinc sulfide (ZnS), titanium dioxide (TiO₂), and iron oxide (Fe₂O₃).

The vibration-damping inorganic material may have a specific weight of 3.0 to 6.0.

A polyamide resin composition with reduced radiation noise according to the present disclosure provides an effect of reducing the amplitude of noise by damping the amplitude of vibration generated from the surface of an engine part to suppress the degree to which the vibration is changed into radiation sound.

The technical problems which the present disclosure intends to solve are not limited to the technical problems which have been mentioned above, and other technical problems which have not been mentioned will be apparently understood by a person with ordinary skill in the art from the description of the present disclosure.

### BRIEF DESCRIPTION OF THE DRAWINGS

FIG. 1 is a cross-sectional view in which a radiation noise is generated by vibration of parts.

FIG. 2 is a schematic view illustrating a vibration test method of a sample according to an exemplary embodiment of the present disclosure.

FIG. 3 is a schematic view illustrating a vibration test measurement of a sample according to an exemplary embodiment of the present disclosure.

FIG. 4 is a graph illustrating a vibration test result according to the present disclosure.

FIG. 5 is a graph illustrating a method of calculating vibration damping characteristics according to an exemplary embodiment of the present disclosure.

### DETAILED DESCRIPTION OF THE EMBODIMENTS

Hereinafter, exemplary embodiments of the present disclosure will be described in detail. Prior to the description, terms or words used in the specification and the claims should not be interpreted as being limited to a general or dictionary meaning and should be interpreted as a meaning and a concept which conform to the technical spirit of the present disclosure based on a principle that an inventor can appropriately define a concept of a term in order to describe his/her own invention by the best method. Accordingly, since the exemplary embodiments described in the present specification are only a most preferred exemplary embodiment of the present disclosure and do not represent all of the technical spirit of the present disclosure, it should be understood that various equivalents and modified examples, which may replace these exemplary embodiments, are possible at the time of filing the present application.

As various technologies for increasing the output and the torque while reducing the size of an engine are combined, the vibration of the engine further intensifies, and the amplitude of the noise caused by the vibration is also further increased.

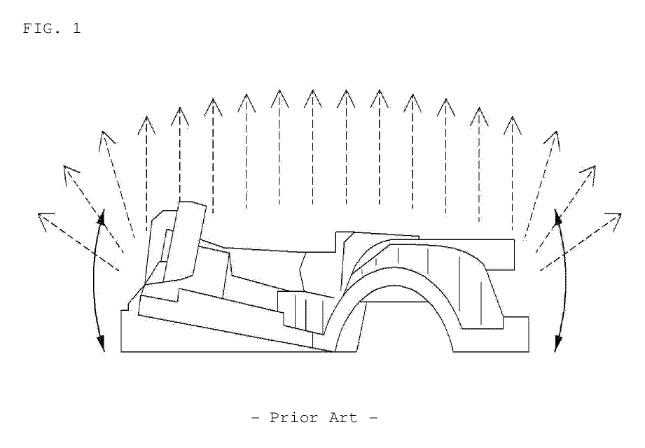

FIG. 1 is a cross-sectional view in which a radiation noise is generated by vibration of parts, and the engine parts in FIG. 1 may be a cylinder head cover, a timing belt/chain cover, and an engine oil pan part, which are cover parts mounted on an automotive engine. Through FIG. 1, it can be confirmed that as engine parts are vibrated up and down during the driving of an engine, radiation sound is generated by vibration from the surface of the part. The vibration and the radiation noise may greatly affect durability and stability of a vehicle, and the present disclosure has been made in an effort to solve the problem.

According to the related art, a polymer having a relatively better vibration damping capacity and a higher damping ratio than a metal is being applied to a cylinder head cover, a timing belt/chain cover, and an engine oil pan part, which are cover parts mounted on an automotive engine. In particular, the polymer is glass fiber-reinforced polyamide 66, and the vibration damping capacity level is only at a level of the damping ratio of 3.0 to 3.5%.

Thus, the present disclosure has been made in an effort to suppress the amplitude of vibration generated from the surface of an engine by significantly improving the vibration damping capacity as compared to a level of a damping ratio of 3.0 to 3.5%, which is a damping capacity level of a material according to the related art, and to reduce the amplitude of radiation sound.

Hereinafter, the present disclosure will be described in detail. The present disclosure relates to a polyamide resin composition with reduced radiation noise.

In the present disclosure, a vibration-damping inorganic material is applied in order to improve the vibration damping capacity of a polyamide 66 material, and simultaneously, a coupling agent is used in order to enhance the compatibility between the inorganic material and a resin.

That is, a plastic engine part manufactured by using the composition according to the present disclosure may obtain an effect of reducing the amplitude of noise by damping the amplitude of vibration when the vibration generated from the motion between a piston and a crankshaft is transferred to the plastic part, to suppress the degree to which the vibration is changed into radiation sound.

When the present disclosure is more specifically described, provided is a polyamide resin composition with reduced radiation noise, including 50 to 66 wt % of polyamide 66, 30 to 40 wt % of glass fiber, and 3 to 5 wt % of a vibration-damping inorganic material, based on the entire resin composition.

In the present disclosure, 0.3 to 1.0 wt % of an amino silane coupling agent may be further included. The amino silane coupling agent according to the present disclosure serves to enhance the compatibility between polyamide 66 and the vibration-damping inorganic material, and there may occur problems in that when the amino silane coupling agent is present in an amount of less than 0.3 wt %, the dispersibility of the resin deteriorates due to the insufficient compatibility, and when the amino silane coupling agent is present in an amount of more than 1.0 wt %, surface characteristics deteriorate due to the problems in that the amino silane coupling agent is eluted from the surface and gases are generated. Further, the amino silane coupling agent may be a silane-based material having an organic functional group, such as a vinyl group, an epoxy group, a mercaptan group, and an amine group. Furthermore, as the amino silane coupling agent in the present disclosure, z-6121 manufactured by Dow Corning Corporation was used.

In the present disclosure, the polyamide 66 may have a relative viscosity of 2.7 to 3.5 (a solution having 1 g of polyamide 66 resin in 100 ml of 96% sulfuric acid at 20° C.). More specifically, the composition of the present disclosure has problems in that when polyamide 66 used has a relative viscosity of less than 2.7, the rigidity, the impact strength, and the heat resistance deteriorate, and when polyamide 66 has a relative viscosity of more than 3.5, excessive friction heat is generated between a screw in a molding machine and a resin, and the resin is decomposed or high pressure is required for molding, and as a result, it is difficult to perform an injection molding due to the generation of excessive force between the molding machine and a mold. Accordingly, in the present disclosure, the relative viscosity of the polyamide 66 is limited to 2.7 to 3.5, but is not limited thereto.

The polyamide 66 may have a number average molecular weight of 20,000 to 50,000. When polyamide 66 has a number average molecular weight of less than 20,000, there is a problem in that the rigidity deteriorates, and when polyamide 66 has a number average molecular weight of more than 50,000, the flowability is not good due to the high viscosity, so that a problem may occur during the melt kneading. Accordingly, in the present disclosure, the number average molecular weight of the polyamide 66 is limited to 20,000 to 50,000, but is not limited thereto. Furthermore, as the polyamide 66, PA66 Vydyne 50BW manufactured by Ascend Laboratories was used, and in order to prepare a resin composition according to the present disclosure, the PA66 Vydyne 50BW was prepared in the form of a chip and used after being sufficiently dried in a dehumidification-type dryer.

In the present disclosure, the glass fiber may have a diameter of 8 to 15 μm and is in the form of a chop. There are problems in that when the glass fiber has a diameter of less than 8 μm, the glass fiber is easily broken, and as a result, the rigidity is insufficiently enhanced, and when the glass fiber has a diameter of more than 15 μm, the glass fiber is not easily broken, and as a result, the rigidity is enhanced, but excellent appearance quality may not be obtained due to the problem in that the glass fiber protrudes from the surface thereof. Accordingly, in the present disclosure, the diameter of the glass fiber is limited to 8 to 15 μm, but is not limited thereto.

The glass fiber may have a length of 2 to 5 mm. There occur problems in that when the glass fiber has a length of less than 2 mm, it is insufficient to enhance the rigidity due to the short length of the glass fiber, and when the glass fiber has a length of more than 5 mm, the rigidity is enhanced, but excellent appearance quality may not be obtained due to the problem in that the glass fiber is long and protrudes. Accordingly, in the present disclosure, the length of the glass fiber is limited to 2 to 5 mm, but is not limited thereto.

The content of the glass fiber may be 30 to 40 wt % based on the entire polyamide resin composition. There are problems in that when the content of the glass fiber is less than 30 wt %, an effect of imparting rigidity may be minimal, and when the content of the glass fiber is more than 40 wt %, the effect of imparting rigidity is excellent, but the glass fiber protrudes from the surface thereof, and as a result, appearance quality may deteriorate, and warpage and distortion of a molded article may frequently occur. Accordingly, the content of the glass fiber according to the present disclosure is limited to 30 to 40 wt %, but is not limited thereto. Furthermore, as the glass fiber according to the present disclosure, CS311 manufactured by KCC Corporation was used, and as the surface, a surface treated with a coupling treatment agent was used.

The present disclosure includes a vibration-damping inorganic material. In the present disclosure, the vibration-damping inorganic material is used in order to enhance an effect of strengthening surface characteristics of a polyamide resin composition and an effect of blocking the transfer of vibration. That is, in the present disclosure, the glass fiber is used in order to reinforce the strength of a polyamide resin composition, but when only the glass fiber is used, a vibration-damping inorganic material is added in order to enhance an effect of blocking the noise because it is difficult to secure excellent surface characteristics due to protrusion of the glass fiber from the surface thereof, the flow marks, and the like.

According to the present disclosure, the vibration-damping inorganic material may be selected from antimony oxide (Sb₂O₃), barium sulfate (BaSO₄), zinc oxide (ZnO), zinc sulfide (ZnS), titanium dioxide (TiO₂), and iron oxide (Fe₂O₃).

However, the higher the difference between the specific gravity of the vibration-damping inorganic material and the specific gravity of a base polymer is, the more easily a phenomenon in which the vibration is suppressed from being transferred occurs, so that it is preferred to use a vibration-damping inorganic material having a relatively high specific gravity. More specifically, if an additive having a large difference in specific gravity compared to the base polymer is included, an impedance mismatch phenomenon in which the vibration in a matrix is suppressed from being transferred occurs, and the more clearly the phenomenon is exhibited, the better the vibration-damping capacity is. Simultaneously, the better the energy absorption capacity of the additive is, the more significant the effect is.

Accordingly, in the present disclosure, as the vibration-damping inorganic material, those having a specific gravity equal to or more than 3.0 to 6.0 may be selected. When the specific gravity is less than 3.0, it is effective for enhancing the mechanical strength, but the specific gravity is similar to the gravity (2.4 to 2.6) of the glass fiber, so that vibration insulation characteristics are minimal due to an effect in that the mass of a material per unit area is increased. Further, in the case of a vibration-damping inorganic material having a specific gravity of more than 6.0, the processability is poor when the vibration damping inorganic material is mixed and processed with plastics due to the high specific gravity, and the vibration-damping inorganic material is not suitable for being applied as a plastic reinforcing agent.

The content of the vibration-damping inorganic material may be 3 to 5 wt %. When the content of the vibration-damping inorganic material is less than 3 wt %, there is a problem in that an effect of improving vibration damping characteristics caused by a vibration-damping inorganic material becomes minimal, and when the content is more than 5 wt %, there is a problem in that mechanical properties such as impact strength deteriorate. Therefore, in the present disclosure, the content of the vibration-damping inorganic material is limited to 3 to 5 wt %, but is not limited thereto.

### Examples

Hereinafter, the present disclosure will be described in more detail through Examples. These Examples are only for exemplifying the present disclosure, and it will be obvious to those skilled in the art that the scope of the present disclosure is not interpreted to be limited by these Examples.

[Preparation Method]

A polyamide resin composition with reduced radiation noise according to the present disclosure may be prepared by applying the components as described above, that is, polyamide 66, glass fiber, a vibration-damping inorganic material, and an amino silane coupling agent to an extruder and extruding the resulting mixture.

Specifically, the polyamide resin composition may be prepared by kneading the components of the polyamide resin composition as described above at 240° C. to 280° C. using a biaxial screw extruder.

In this case, in order to maximize the kneading of the polyamide resin composition, by using an extruder having three inlets, a polyamide resin is introduced into the primary inlet, and an additive such as an impact modifier may be together introduced in some cases. Vibration-damping inorganic material particles are introduced into the secondary inlet, and glass fiber is introduced into the tertiary inlet. Further, during the melt kneading, the residence time is minimized in order to prevent the polyamide resin composition from being thermally decomposed, and the rotation of the screw is adjusted to approximately 150 to 800 rpm in consideration of the dispersibility of the polyamide resin composition.

As described above, the polyamide resin composition according to the present disclosure may include a polyamide resin, glass fiber, a vibration-damping inorganic material, an amino silane coupling agent, and an impact modifier, and has an excellent effect in terms of noise blocking characteristics while maintaining excellent tensile strength, flexural strength, flexural modulus, and impact strength, and the effect may be confirmed through the following test and evaluation results.

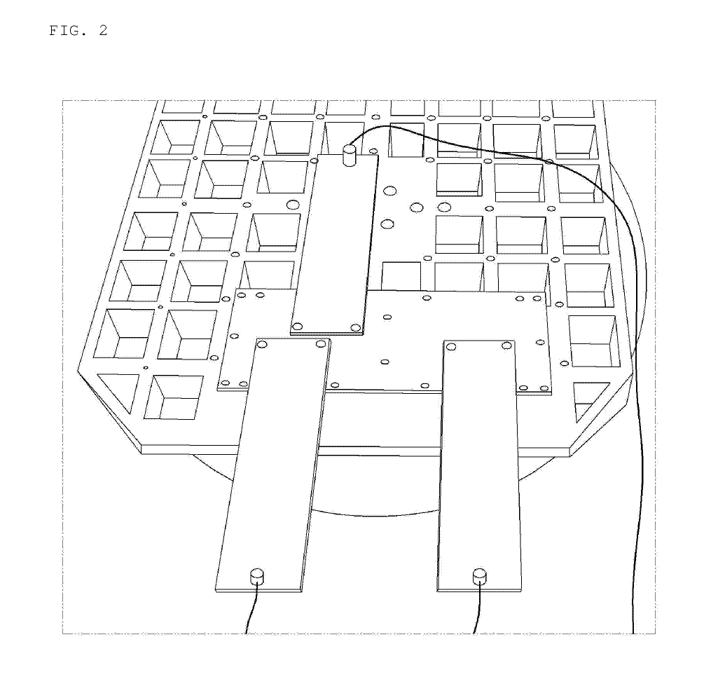

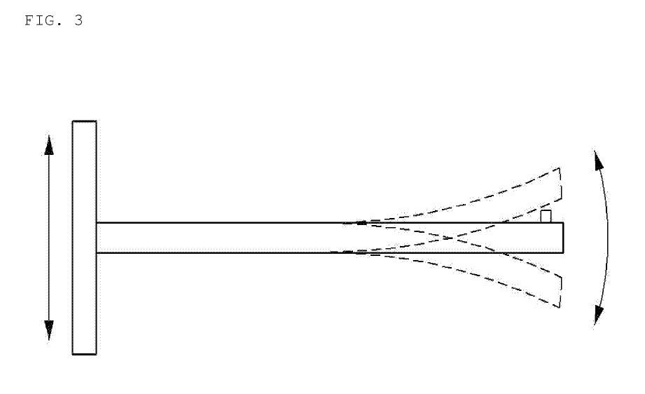

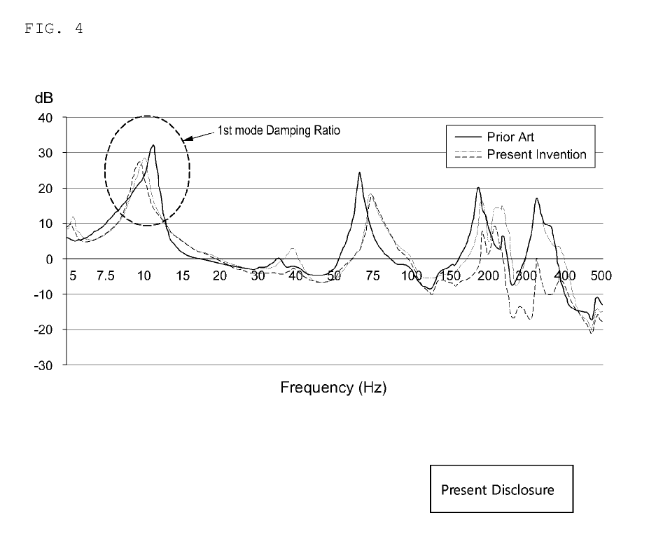

FIG. 2 is a schematic view illustrating a vibration test method of a sample according to the present disclosure, and FIG. 3 is a schematic view illustrating a vibration test measurement of a sample according to the present disclosure. Through the vibration test instrument and method, the sample including the composition according to the present disclosure was tested, and the upward and downward shaking was transferred from the left side in FIG. 3, and the vibration was sensed by an acceleration sensor positioned at the right end, and the vibration and radiation noise was measured. More specifically, a sample is manufactured such that the sample can be vibrated up and down like an actual engine part, an acceleration sensor is mounted, a frequency is measured by the acceleration sensor, and results are illustrated in FIG. 4.

FIG. 4 is a graph illustrating a vibration test result according to the present disclosure. As marked in FIG. 4, the horizontal axis indicates the frequency (Hz), and the vertical axis indicates the size (dB) of radiation noise. That is, FIG. 4 is a test result illustrated by using the vibration test and measurement methods in FIGS. 2 and 3. The circular mark in FIG. 4 indicates a 1^{st} mode damping ratio, and it can be confirmed that as the frequency is increased, the amplitude of radiation noise is gradually decreased.

More specifically, the amplitudes of vibration may be relatively compared by comparing the intensities of the Y axis (dB) values in FIG. 4, and the Y-axis scale indicates a 10 multiple of the logarithm, and the negative (−) value means a value equal to or less than a decimal point of the quantitative value. The solid line in FIG. 4 indicates the amplitude of vibration according to the related art, and the dotted line indicates the amplitude of vibration according to the present disclosure. Through the lines, it is possible to elicit an indirect comparison from the dotted line according to the present disclosure that the noise caused by radiation is relatively small in terms of the amplitude of vibration compared to the related art.

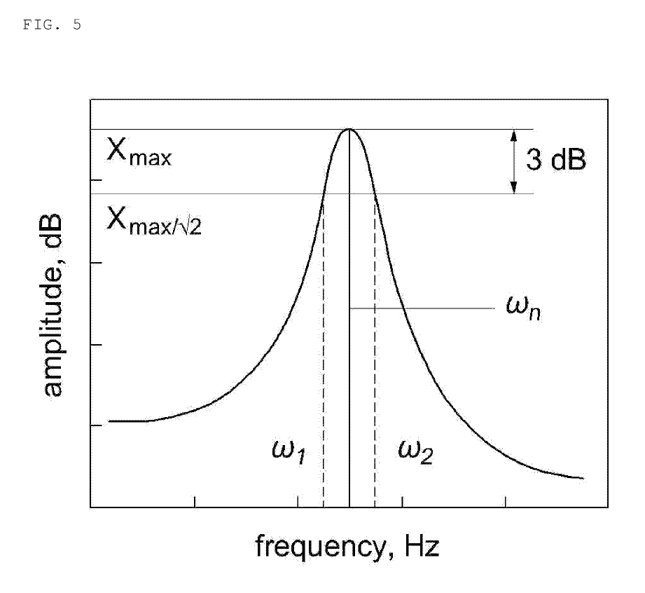

Through FIG. 4, the damping capacities may be compared by comparing the degrees of sharpness of the peaks. The degrees of sharpness of the peaks may be compared by referring to the graph in FIG. 5 and converting the values. FIG. 5 is a graph illustrating a method of calculating vibration damping characteristics according to the present disclosure. More specifically, the graph in FIG. 5 is used in order to obtain the result values in FIG. 4, that is, calculate vibration damping characteristics. Furthermore, a damping ratio showing the vibration damping characteristics follows the following equation.

$$ζ ( damping ratio ) = \frac{{ω}_{2} - {ω}_{1}}{2 {ω}_{n}}$$

That is, in the Y-axis values at the left and right sides based on the peak point in FIG. 4, when the X-axis (Hz) values of the points below 3 dB are designated as ω1 and ω2, respectively, and the Hz of the peak point is designated as ωn, damping characteristics may be compared by relatively comparing the values of r=(ω2−ω1)/ωn. In the peak points in FIG. 4, the sharper the shape is, the smaller the r value is, and the gentler the shape is, the larger the r value is. Accordingly, it can be confirmed that the r value of the dotted line is larger than that of the solid line, and accordingly, it can be seen that the present disclosure has better damping characteristics than the related art.

Through FIGS. 4 and 5, it can be seen that the present disclosure suppresses the amplitude of vibration and has excellent damping characteristics, compared to the related art.

The polyamide resin composition according to the present disclosure exhibits physical properties in which a tensile strength measured in accordance with the ASTM evaluation method D638 is 1,900 kg/cm² to 2,350 kg/cm², a flexural strength measured in accordance with the ASTM evaluation method D790 is 3,100 kg/cm² to 3,400 kg/cm², and an impact strength measured in accordance with the ASTM evaluation method D256 is 130 J/m to 140 J/m, and may be applied to an automotive engine room part. In particular, the present disclosure is suitable as a material for preparing a cylinder head cover of a vehicle, which requires mechanical properties such as strength and simultaneously, noise blocking characteristics.

Hereinafter, Examples prepared by the preparation method and test will be suggested in order to help understanding of the present disclosure. However, the following Examples are provided only to more easily understand the present disclosure, and the contents of the present disclosure are not limited by the Examples.

TABLE 1

| Classification | Example (wt %) | | | | | | | | | | |
|---|---|---|---|---|---|---|---|---|---|---|---|
| (parts by weight) | 1 | 2 | 3 | 4 | 5 | 6 | 7 | 8 | 8 | 10 | 11 |
| Nylon 66 | 62 | 61 | 60 | 65 | 61 | 61 | 63 | 59 | 58 | 57 | 57 |
| Glass fiber | 35 | 35 | 35 | 35 | 35 | 35 | 35 | 35 | 35 | 35 | 35 |
| Vibration- | — | — | — | — | — | 4 | — | — | 4 | 4 | — |
| Damping | | | | | | | | | | | |
| Inorganic | | | | | | | | | | | |
| Material_#1 | | | | | | | | | | | |
| (BaSO₄) | | | | | | | | | | | |
| Vibration- | 3 | 4 | 5 | — | — | — | 2 | 6 | 3 | 4 | 4 |
| Damping | | | | | | | | | | | |
| Inorganic | | | | | | | | | | | |
| Material_#2 | | | | | | | | | | | |
| (Sb₂O₃) | | | | | | | | | | | |
| Vibration- | — | — | — | — | 4 | — | — | — | — | — | 4 |
| Damping | | | | | | | | | | | |
| Inorganic | | | | | | | | | | | |
| Material_#3 | | | | | | | | | | | |
| (ZnO) | | | | | | | | | | | |

TABLE 2

| | Test | | Example | | | | | | | | | | |
|---|---|---|---|---|---|---|---|---|---|---|---|---|---|
| Item | Method | Unit | 1 | 2 | 3 | 4 | 5 | 6 | 7 | 8 | 8 | 10 | 11 |
| Tensile | ASTM | Kgf/cm2 | 2013 | 1952 | 1902 | 2350 | 1790 | 1550 | 2167 | 1834 | 1490 | 1400 | 1714 |
| strength | D792 | | | | | | | | | | | | |
| Flexural | ASTM | Kgf/cm2 | 3279 | 3409 | 3150 | 2956 | 2518 | 1810 | 3204 | 2920 | 2250 | 1830 | 1983 |
| strength | D790 | | | | | | | | | | | | |
| Impact | | J/m | 140 | 136 | 133 | 165 | 124 | 82 | 140 | 102 | 74 | 55 | 105 |
| strength | | | | | | | | | | | | | |
| Surface | Naked eye | — | Good | Good | Good | Good | Good | Good | Good | Poor | Good | Poor | Poor |
| characteristics | decision | | | | | | | | | | | | |
| Vibration | (*) | % | 4.3 | 4.4 | 4.5 | 3.2 | 4.1 | 3.9 | 3.8 | 4.5 | 4.5 | 4.7 | 4.6 |
| damping | | | | | | | | | | | | | |
| characteristics | | | | | | | | | | | | | |
| (Damping | | | | | | | | | | | | | |
| ratio) | | | | | | | | | | | | | |

For reference, as the vibration-damping inorganic materials according to the present disclosure, which are described in Tables 1 and 2, KCB-8000 barium sulfate (specific gravity 4.5 g/cc) manufactured by KOCH Co., Ltd., KS-1 zinc oxide (specific gravity 5.5 g/cc) manufactured by Hanil Chemical Ind. Co., Ltd., and KCNAP-400 antimony oxide (specific gravity 4.5 g/cc) manufactured by KOCH Co., Ltd. were used.

According to the result in Table 2, it can be confirmed that Examples 1 to 3 have excellent mechanical strength, surface characteristics, and vibration performance compared to Examples 4 to 11, and Examples 1 to 3 have excellent vibration damping characteristics compared to Examples 4 to 7. In addition, according to the result in Table 2, it can be seen that Examples 1 to 3 have excellent surface characteristics compared to Examples 8, 10, and 11, and Examples 1 to 3 have excellent mechanical strength compared to Examples 5, 6, and 8 to 11.

According to the result in Table 2, it can be confirmed that on the whole, as the content of the vibration-damping inorganic material is increased, the surface characteristics and the mechanical strength become poor. However, in the case of the vibration-damping inorganic material Sb₂O₃, it can be seen that as the content is increased, vibration damping characteristics are excellent. Accordingly, according to the present disclosure, it can be said that it is most preferred to use Sb₂O₃ as a vibration-damping inorganic material.

It can be confirmed that the damping ratio exhibiting vibration damping characteristics of the resin composition according to the present disclosure is about 4.0% on average, and is much better than the related art, which is at a level of 3.0 to 3.5%.

That is, the polyamide resin composition with reduced radiation noise according to the present disclosure provides an effect of reducing the amplitude of noise by damping the amplitude of vibration generated from the surface of an engine part to suppress the degree to which the vibration is changed into radiation sound.

As described above, the present disclosure has been described in relation to specific exemplary embodiments of the present disclosure, but the specific exemplary embodiments are only illustrative and the present disclosure is not limited thereto. The exemplary embodiments described may be changed or modified by those skilled in the art to which the present disclosure pertains without departing from the scope of the present disclosure, and various alterations and modifications are possible within the technical spirit of the present disclosure and the equivalent scope of the claims which will be described below.

What is claimed is:

1. A polyamide resin composition with reduced radiation noise, comprising:
50 to 66 wt % of polyamide 66, 30 to 40 wt % of glass fiber, and 3 to 5 wt % of a vibration-damping inorganic material, based on the entire polyamide resin composition.

2. The polyamide resin composition of claim 1, further comprising:
0.3 to 1.0 wt % of an amino silane coupling agent based on the entire polyamide resin composition.

3. The polyamide resin composition of claim 1, wherein the polyamide 66 has a relative viscosity of 2.7 to 3.5.

4. The polyamide resin composition of claim 1, wherein the polyamide 66 has a number average molecular weight of 20,000 to 50,000 g/mole.

5. The polyamide resin composition of claim 1, wherein the glass fiber has a diameter of 8 to 15 μm.

6. The polyamide resin composition of claim 1, wherein the glass fiber has a length of 2 to 5 mm.

7. The polyamide resin composition of claim 1, wherein the vibration-damping inorganic material is selected from the group consisting of antimony oxide (Sb₂O₃), barium sulfate (BaSO₄), zinc oxide (ZnO), zinc sulfide (ZnS), titanium dioxide (TiO₂), and iron oxide (Fe₂O₃).

8. The polyamide resin composition of claim 1, wherein the vibration-damping inorganic material has a specific gravity of 3.0 to 6.0.
